(19) United States
(12) Patent Application Publication
(10) Pub. No.: US 2018/0163364 A1
(43) Pub. Date: Jun. 14, 2018

(54) SAFETY SYSTEM FOR MOBILE APPARATUS

(71) Applicant: HUDSON BAY HOLDING B.V., 's-Heer Arendskerke (NL)

(72) Inventor: Leendert Wilhelmus Cornelis HUISSOON, `s-Heer Arendskerke (NL)

(21) Appl. No.: 15/566,944

(22) PCT Filed: Apr. 14, 2016
(86) PCT No.: PCT/NL2016/050262

§ 371 Date: Oct. 16, 2017

(30) Foreign Application Priority Data
Apr. 17, 2015 (NL) 2014663
Oct. 9, 2015 (NL) 2015595

(51) Int. Cl. E02F 3/43; B60G 13/06; B60G 17/08; E02F 9/02; B60R 19/02; B60R 19/38; E02F 3/32; B62D 21/00; E02F 3/30; E02F 9/20; B60G 17/005; E02F 9/22; E02F 9/26

(52) U.S. Cl. CPC E02F 3/439; B60G 2500/32; B60G 17/08; E02F 9/028; B60R 19/02; B60R 19/38; E02F 3/32; B62D 21/00; E02F 3/301; E02F 9/2004; B60G 17/005; E02F 9/2025; E02F 9/2271; E02F 9/264; B60G 2500/10; B60G 13/06

(57) ABSTRACT

Mobile apparatus comprising a main frame with displacing means; a sub-frame connected rotatably to the main frame; an operating arm connected to the sub-frame and comprising at least a first and a second articulation which are connected pivotally to each other, which operating arm can be transformed from an operating position to a transport position; drive members configured to move at least the first and second articulations of the operating arm; operating instruments controllable by a driver and provided close to a driver position on the sub-frame; measuring instruments configured to measure position data relating to a position of the first articulation and a position of the second articulation; and a control system configured to receive operational data from the operating means and position data from the measuring instruments; and configured to control the drive members in accordance with the received position data and the operational data.

### FIELD OF THE INVENTION

The present invention relates to the field of mobile apparatuses, such as for instance tractors, excavators, wheel loaders, arm mowers, forestry machines, hoisting cranes, working machines capable of road travel, and combinations thereof.

### BACKGROUND

Known excavators have a main frame and a rotatable sub-frame. These types of machine can have the motor for the drive in the main frame or in the rotatable sub-frame. Other known mobile apparatuses are a tractor with a front-loader or any wheel loader, also referred to as loading shovel.

Said types of machine can have tyres or caterpillar tracks.

Said machines sometimes have an electronic system in which digital command data and measurement data are converted to a movement by an electrical, pneumatic, hydraulic or mechanical control. Such system is for instance implemented as a so-called controller area network (CAN) bus system. There are different types of CAN bus system, such as CAN-Open, J1939, Byteflight, D2B, VAN, and the Flex Ray standard. ISO-bus is for instance a standardized system for communication and data exchange between a tractor and tractor implement.

Such machines can be equipped with measuring instruments such as sensors in order to measure positions of parts of the machine.

The above stated solutions can be used in mobile apparatuses with a single function, for instance an excavator function or a loading shovel function or a tractor function or a crane/lift function, or a mowing arm function or a tree clearance function. It is thus known for instance to measure with sensors the depth of an excavator bucket during operation or to measure the load/bulk load in the bucket. In known tractors sensors are applied to measure the height of the lifting device, and so of the implement, this so as to be able to monitor the depth of a plough or milling cutter.

The degrees of freedom which parts of known single function mobile apparatuses have are often limited mechanically or hydraulically in order to prevent collisions of different parts of the machine. The angular rotation of an excavator bucket of an excavator and/or the angular rotation on the arm of this excavator is for instance selected such that a standard excavator cannot move against the digging arm or against the cab.

In known loading shovels or front-loaders or wheel loaders the geometry can be chosen such that the implement or the loading bucket has maximum force in the lowest position and nevertheless realizes a properly restricted angle of the bucket in the highest position of the lifting arm, this in order to prevent discharge to the wrong side (the cab side).

WO03066981 in the name of applicant describes a mobile apparatus with an operating arm which can be folded from an articulated operating arm to a single lifting arm, and vice versa. NL1027370 in the name of applicant describes a mobile apparatus with adjustable control patterns. NL1035694 in the name of applicant describes a mobile apparatus with foldable arm in combination with a lifting device on the main frame. This lifting device can for instance be used for agricultural, forestry and mowing implements. Embodiments with caterpillar tracks are typically not spring-mounted. Embodiments with tyres are typically spring-mounted with the damping of the tyres. The movement speed is hereby typically limited to about 40 km/h because otherwise—through “bouncing” on the ground surface and the lack of good contact with the ground surface—safety is compromised.

### SUMMARY OF THE INVENTION

According to a first aspect, the invention relates to a mobile apparatus comprising a main frame with displacing means; a sub-frame connected rotatably to the main frame; an operating arm connected to the sub-frame, drive members, operating instruments controllable by a driver, measuring instruments and a control system. The operating arm comprises at least a first and a second articulation (also referred to as arm segment) which are connected pivotally to each other. The operating arm can be transformed from an operating position to a transport position. The drive members are configured to move at least the first and second articulations of the operating arm. The operating instruments are provided close to a driver position on the sub-frame. The measuring instruments are configured to measure position data relating to a position of the first articulation and a position of the second articulation. The control system is configured to receive operational data from the operating means and position data from the measuring instruments; and to control the drive members in accordance with the received position data and the operational data.

By taking into account operational data on the one hand and measured position data on the other the drive members can be controlled in an improved manner and the movement of the operating arm can be better controlled.

According to a preferred embodiment, the operating instruments comprise a transport position command instrument which can be operated by a driver in order to move the operating arm to the transport position and which is configured to transmit a transport position command to the control system. The control system can then be configured, after receiving a transport position command, to control the drive members on the basis of the position data during the movement to the transport position. The operating arm can in this way be moved in a safe, well controlled manner to the transport position. The control system is preferably configured to receive position data from the measuring instruments at successive points in time during the movement from the operating position to the transport position and to control the drive members in accordance with these position data received at successive points in time.

According to a second aspect, the invention relates to a mobile apparatus comprising a main frame; displacing means; a sub-frame connected rotatably to the main frame; an operating arm connected to the sub-frame; drive members configured to move the operating arm; a damping system, operating instruments controllable by a driver, and a control system. The damping system is located between the main frame and at least one displacing means for the purpose of damping the movement of the main frame relative to the displacing means. The operating instruments are provided close to a driver position on the sub-frame. The control system is configured to receive operational data from the operating means; and to block the damping system in accordance with the received operational data.

According to an embodiment, a damping system is provided between the displacing means and the main frame. The damping system is also a stabilizing system to enable the main and sub-frame to be stabilized and aligned, or held level, relative to the horizontal. A stabilizing and/or levelling system increases the efficiency on uneven terrain, such as on an incline or in the mountains.

Existing mobile apparatuses with an untrained operator are found in practice to be susceptible to collisions between parts of the machine. The operating arm can thus collide with the main frame, the displacing means or the lifting device, or the implement can collide with the operating arm or the sub-frame. A simple known solution is to restrict the degrees of freedom of movement mechanically or hydraulically. However, this also limits performance in the different modes, and this is not desirable. Embodiments according to the first aspect can solve this problem.

According to an embodiment, the displacing means comprise tyres or caterpillar tracks. The control system can comprise an electronic control system configured to transfer signals between different components of the mobile apparatus. One or more lifting devices can optionally be provided on the main frame for coupling one or more implements or one or more stabilizing devices. The lifting device can for instance be coupled to agricultural, forestry, mowing or other implements.

According to an embodiment, the operational data is transferred between operating members and the control system and the position data of one or more parts of the apparatus measured by the measuring measurements is transferred to the control system. The data received in the control system is converted to a movement or combination of movements of parts of the mobile apparatus. These movements can be realized by mechanisms, motors, electricity, hydraulics, pneumatics or a combination thereof. It is possible that the control system can also stop the movements.

In an embodiment the control system comprises at least one computer unit and/or a bus system, for instance a CAN bus system and/or a controller and/or an input/output (I/O) interface device and/or an electronic control unit (ECU) for motor vehicles and/or a relay and/or a programmable logic controller (PLC). The CAN bus system can for instance be CAN-Open, J1939, Byteflight, D2B, VAN, the Flex Ray standard or the ISO-bus standard. Simpler control systems without CAN bus are also possible.

According to an embodiment, the displacing means, for instance caterpillar tracks or wheels, are embodied with a damping system. This system enables higher movement speeds.

According to a preferred embodiment, the mobile apparatus comprises a measuring instrument for measuring position data representative of the position of the main frame and/or the sub-frame, wherein the control system is configured to control the damping system in accordance with the measured position data. The control system can then be configured to change the position of the sub-frame on the basis of the measured position data using the damping system. The sub-frame can in this way be positioned for instance substantially level or substantially parallel to the horizontal so that it operates more safely and efficiently. It is also possible to mount the sub-frame at a fixed angle, for instance when carrying out operations on an uneven terrain.

According to yet another option, the angle is varied in accordance with the measured position data, for instance in order to obtain a stable road-holding when the mobile apparatus travels by road.

The damping system, also referred to as suspension or stability system, can be controlled by the control system. Measuring instruments in parts of the damping system measure and transmit position data to the control system. A lifting device, optionally with a power takeoff, can be provided here on the spring-mounted main frame.

According to a preferred embodiment, the mobile apparatus comprises measuring instruments coupled to the control system, wherein the degrees of freedom of movement or positions of parts of the operating arm and/or of the implement are controlled in accordance with the measurement data from the measuring instruments, for instance measurement data representative of the position of the implement in relation to articulations. A feedback circuit/loop can be provided which ensures that an implement on the outer end of the operating arm does not collide with the mobile apparatus in the articulated operating arm position. The rotation of the implement and/or the rotation of the last articulation and/or the rotation of the penultimate articulation can thus be limited in accordance with the measurement data in order to prevent a collision with for instance parts of the operating arm or with the driver. When the driver operates the operating members and wishes to go further than the safety limits allow, the control system will then stop the movement. This stopping can be slow with a speed reduction calculated by the control system.

According to a preferred embodiment, the operating arm comprises at least three articulations and the operating arm is configured to fold the at least three articulations adjacently or against each other in the transport position or in a lifting operating position and/or to lock them relative to each other. Limitations of the degrees of freedom of movement of the operating arm and/or the implement are likewise possible in the lifting arm position or transport position. Positioning of the implement on the outer end of the operating arm can for instance be limited within a determined range. When for instance a loading bucket or pallet fork is coupled and the operating arm is in the transport or lifting position, the rotation angle in the direction of the position of the driver can be limited to a determined value. In a possible embodiment a measuring instrument measures the position or rotation of the implement and the height of the implement relative to the mobile apparatus or ground level. The control system then calculates a limit position and, just as in the articulated operating position, this limit position can be reached with a decreasing speed of movement.

According to a preferred embodiment, the control system is configured to hold the implement parallel to the sub-frame or the main frame on the basis of measurement data from the measuring instruments. It is also possible to input the size/dimensions of the implement coupled to the operating arm and the size/dimensions of the implement in a lifting device, and the control system can use these dimensions to control the drive members.

In an embodiment the measuring instruments and the control system are used for other purposes. Measurement data from the measuring instrument for measuring the position or angular rotation of the implement and from the measuring instrument for measuring the position of the first articulation can for instance be used in order to hold an implement in the arm level or hold it parallel to a set angle relative to the main frame or sub-frame.

In an embodiment the measuring instruments comprise a measuring instrument for measuring the rotation or angle between the main frame and the sub-frame. The control system can in this way calculate whether the implement or the operating arm will make contact with the displacing means. This is also the case for possible contact or collision with a lifting device on the main frame or an implement in a lifting device. The freedom of movement of the operating arm and of the lifting device can be restricted. In the operating arm these are particularly the last part and the penultimate part.

In an embodiment the measuring instruments comprise a measuring instrument for measuring the height or position or angular rotation of the lifting device or of an implement in the lifting device. A decreasing speed and final stopping of the movement can once again be calculated by the control system.

When the mobile apparatus is embodied with a damping system, measurement data from measuring instruments of the displacing means can then also serve as input for the control system. In the case of an uneven terrain, and when the displacing means is in a high position, operation with the operating arm can for instance then take place less close to that side of the mobile apparatus than when a displacing means is in a lower position.

In a possible embodiment the control system can prevent collisions for each of the different modes by combining the operational data from the operating members and the measurement data from the measuring instruments. The control system can be further configured here to take make allowance for priorities of the driver.

In a possible embodiment the position data for a component of the mobile apparatus measured by a measuring instrument can be used for several functions. The measuring instrument for measuring the position of the implement on the arm can thus be used to avoid collisions in both the articulated operating position and the folded-together lifting operating position. The same measuring instrument can be used to bound the rotation of the loading shovel in the uppermost position. This measuring instrument can also be utilized to automatically fold up the articulated arm, wherein the quick change system of the implement on the operating arm is held as close as possible against the last arm articulation.

In an embodiment the measuring instrument for measuring the position of the first articulation can be used for several purposes. The measurement data from this measuring instrument can for instance be used for automatic folding-up and/or for controlling the angle between the operating arm and the sub-frame or main frame in the articulated operating arm position and/or to control the angle between the operating arm and the main frame or sub-frame in the transport position.

In an embodiment the control system is configured for the purpose, during automatic folding up of the articulated arm to a lifting operating position or transport position and vice versa, of using the measurement data from the measuring instruments of the articulations to control the drive members in order to hold in position or rotate the articulations. In an exemplary embodiment with at least three articulations the third and last articulation is held in position during folding-up by for instance building up and maintaining pressure in the case of a cylinder as drive member. This can also be the case for the second articulation when it is held in position in line with the first articulation.

In an exemplary embodiment with a quick change system mounted on the last articulation for coupling of the implement thereto, the control system controls the drive members such that during folding in or out of the operating arm the changing system is held in a position as close as possible against the last articulation. Collisions are hereby prevented. In the case of an embodiment with a cylinder as drive member the pressure is maintained in this position. With other types of drive member, such as electrical actuators or rotary motors, it is ensured that a determined force exerted by a drive member maintains the position of an articulation.

In an embodiment the control system is configured for the purpose, during locking and unlocking of articulations, of using the measurement data from the measuring instruments to control the drive members. In the case of a cylinder as drive member for folding-in of the second articulation the pressure can thus be maintained in the cylinder during locking. After locking this pressure can then be reduced again. This is also possible during unlocking: the pressure is built up so that the mechanical locking has less resistance during unlocking. The time and pressure for maintaining the pressure and force in the case of cylinders can be determined by the control system. With another type of drive member, such as an electrical, mechanical, pneumatic or other drive member for moving from an articulated position to a single lifting arm, the time and force on a drive member during folding in and out is determined by the control system.

In an embodiment the control system is configured to block the rotation between main frame and sub-frame during the process of transforming the operating arm. Other functions, except for those required for the transformation, can also be blocked by the control system. Safety can in this way remain guaranteed.

According to an embodiment, a mobile apparatus comprises a main frame with wheels or caterpillar tracks. On top of the main frame, usually via a vertical or substantially vertical shaft, there is a rotatable sub-frame with or without a workplace or cab for the driver and with at least one operating arm. In an embodiment the operating arm is transformable from an articulated position with a plurality of articulations to a transport position or single lifting arm position. The function of the operating arm hereby changes from an articulated crane, lifting, mowing, forestry, personnel lifting or excavating arm to a form wherein the view of the road from the driver position is improved. In the lifting operating position the operating arm can function as lifting arm (with for instance a loading shovel, pallet or transport mode) to which implements can be coupled. The number of articulations can vary, wherein three articulations are preferred.

According to an embodiment with damping system between the main frame and the displacing means (for instance wheels or caterpillar tracks), the damping system can be of differing types. An independent damping means can for instance be provided per displacing means such as a caterpillar or wheel. The wheels or caterpillar tracks, or the axles thereof can be connected via longitudinal arms, transverse arms or inclining arms to the main frame. A double wishbone suspension, a MacPherson suspension or other independent suspension is also possible. Spring-mounted axles can also be used, wherein a plurality of displacing means are mounted on the same axle. These axles can have longitudinal arms, leaf springs, coil springs, air bellows or other types of suspension. The displacing means can be connected via a construction to the main frame, wherein the main frame has a device for bringing about rotation of the sub-frame. In the case of longitudinal arms between the main frame and the displacing means, or axles on which displacing means are positioned, these longitudinal arms are preferably connected to a support structure, such as a bearing or a gear ring, which allows rotation of the sub-frame.

In an embodiment a lifting device for coupling of implements can be connected directly to a main construction of the main frame, i.e. connected directly to the main construction on which a support structure, typically a bearing or a gear ring, is provided for the rotatable sub-frame. At least one power takeoff for driving implements coupled to the lifting device can also be provided on the main construction. This is therefore a spring-mounted lifting device optionally combined with a spring-mounted power takeoff. In the case of an implement with a mass in the lifting device on the main frame, the implement therefore also has a spring-mounted suspension.

In another embodiment at least one lifting device for coupling implements and/or at least one power takeoff is connected directly to one of the displacing means. These are in that case not spring-mounted.

Provided in an embodiment are measuring instruments which directly measure the position of the displacing means. The control system can also be configured to determine the position indirectly by means of geometric calculations. One embodiment is that a linear measuring instrument operates in or at a damping unit, for instance a hydraulic or pneumatic cylinder or bellows. The damping unit can be part of the damping system. In an embodiment a measuring instrument can thus be mounted per wheel or caterpillar track and the measurement data can be used by the control system to actively control the damping system such that the damping system fulfils for instance a suspending or a stabilizing function. In an embodiment it is thus possible that measuring instruments measure the three-dimensional position, including tilting, yaw and steering angle of the main frame or sub-frame and that the control system controls the damping system in accordance with the measurement data. This can also be the case during travel, and the measuring instruments and the control system can then provide for a more comfortable travel performance and simultaneously hold the sub-frame with operating arm level. In an embodiment the damping system can be blocked so that a stable main frame which is not spring-mounted is obtained in for instance the excavating, loading shovel or lifting position. The damping system can also be partially blocked, for instance only the damping units of the front displacing means or only the rear displacing means or on one side or only of a single displacing means. A preset height during fixing of the damping system is also possible. Yet another embodiment provides for fixing of the damping units of one or more displacing means which the control system measures or predicts, for instance on the basis of the rotation speed and/or the angle of the sub-frame and for instance the pressure measured on one or more damping units, have the most force exerted thereon by the rotation of the sub-frame with operating arm.

In an embodiment the damping system is combined with an anti-lock braking system (ABS) of the displacing means. In an embodiment the displacing means are provided with measuring instruments for collecting measurement data for use in the ABS system which is part of the control system of the mobile apparatus. This ABS system provides for a better and safer braking characteristic of the mobile apparatus, and the displacing means in particular. The steering characteristic hereby also becomes safer during braking. The measuring instruments are coupled here to the control system which determines the travel and/or braking and/or steering performance of the mobile apparatus. Legal requirements can be taken into account here. The values measured in the main frame by the measuring instruments are combined with the brake pressure built up in the sub-frame. Data for the brake force or brake pressure in the sub-frame is transmitted via a medium (oil, air or other medium) under pressure or via an electronic control signal to the main frame. In the case of a medium under pressure this takes place for instance via a swivel joint. An electronic control signal for the ABS system can pass via a so-called slip ring. Control signals from and to the damping system in the main frame can also pass via the slip ring to the sub-frame. The control system can be a combined system for controlling the ABS system and the damping system, but can also consist of a number of sub-control systems. This combined control system can further also be configured to receive a measurement signal and/or to transmit a control signal for the steering angle of the displacing means. In an embodiment the front displacing means can have a different, and even opposite, steering angle to the rear displacing means. The front displacing means and the rear displacing means can more generally be co-steered, counter-steered or non-steered.

An embodiment transmits signals from the ABS system in the main frame via the slip ring to a warning system in the sub-frame for the purpose of alerting a driver. The warning system can comprise a digital screen in the cab on which a warning message is displayed. The same screen can be used to display information on the damping system, the one or more steering angles and settings of the steering of the displacing means, etc. The warning signals from the ABS system and/or the brake system can be presented in accordance with legal requirements.

According to an embodiment the operating instruments are provided on the rotatable sub-frame or outside it. The control system, which can comprise a bus system, controls via the drive members the movements of the operating arm and/or the displacing means and/or the associated damping, steering and brake system. This control can for instance be mechanical, hydraulic, pneumatic, electrical or a combination thereof.

In an embodiment the operating instruments on the sub-frame comprise one or more joysticks, buttons or touchscreens or a glove with sensors, or a combination thereof, which are configured to transmit the commands from the driver, optionally via a computer unit, as signals to the control system. In an embodiment a minimum of two buttons are provided which are configured for combined operation in order to realize the transformation from articulated operating arm to single lifting arm, and vice versa. For this purpose a first button for the left hand—on for instance the left-hand joystick—can for instance be operated simultaneously with a second button for the right hand—for instance in the vicinity of the right-hand joystick. According to a variant a single safety button is provided, wherein pressing or sliding several times is necessary to realize the transformation. A further embodiment makes it possible to continue with the transformation after an interruption, for instance when one of the two buttons has been released. The control system recognizes the position and continues the programmed sequence. This is possible in the case of transformation from articulated arm to single lifting arm as well as vice versa. In an embodiment the control system can perform the transformation such that during the transformation only the operating arm can move and the displacing means, and/or the power takeoff and/or the lifting device are not driven. A condition for the transformation may be that the parking brake of the mobile apparatus has been applied. The control system can also be configured, as a condition for the transformation, to verify whether the rotation angle between main frame and sub-frame lies in a determined angular range, for instance an angular range in which the sub-frame faces to the front in the direction of travel.

In an embodiment the control system which transmits the bus signals or commands to for instance a drive member of an articulation, a lifting device or an implement or the damping system comprises a controller which converts electronic signals via different components to mechanical, hydraulic, electrical or pneumatic energy, or combinations thereof. An example is a controller which controls an electrical relay or a hydraulic valve.

In an embodiment the control system comprises a computer unit which can calculate a plurality of measurement data from measuring instruments and, together with the operational data from the operating instruments, can set limits to degrees of freedom of movement. A plurality of computer units can also be used for this purpose.

In an embodiment the mobile apparatus comprises measuring instruments of one or more of the following types: a GPS, a gyroscope, a rotation vector sensor, a gravity sensor, an acceleration sensor. In an embodiment an external computer unit has these sensors available. This external computer unit can be coupled to the control system of the mobile apparatus. Such an external computer unit with sensors can for instance be a laptop, a tablet computer or a mobile phone.

In an embodiment the mobile apparatus comprises measuring instruments in the form of linear sensors, rotation sensors or angle sensors which transmit measurement data to the control system. The sensors can be mounted directly onto the moving parts, such as onto the main frame, the sub-frame or an articulation. The sensors can also perform an indirect measurement, for instance the movement of an actuator or an angle of a rotating part, after which the control system converts these measurement data by means of calculations to a linear displacement or an angular displacement of another part of the mobile apparatus. Other possible measuring instruments measure in a three-dimensional grid, wherein x, y and z coordinates or distances are transmitted to parts of the machine.

In an embodiment the mobile apparatus comprises measuring instruments in the form of an integrated linear sensor in a damping unit such as a hydraulic or pneumatic cylinder or bellows on or at an articulation of the operating arm, wherein the measurement data from the linear sensor is converted to an angular displacement or absolute displacement of the articulation. The rotation of each articulation can thus be measured, and thereby also the displacement of the implement coupled to the last articulation, optionally via a parallelogram linkage By measuring the angle or the displacement of the implement on the operating arm the three-dimensional position of each part of an implement is known and can be controlled. An integrated linear sensor can be used as measuring instrument herefor which measures the angular rotation of the implement. A linear sensor in a drive member is for instance mounted in a cylinder rod.

In an embodiment the sub-frame can have a limited rotation, rotate through 360 degrees or have unlimited rotation. The measuring instrument for measuring the rotation angle between the main frame and the sub-frame is preferably a rotation sensor, but can also be another type of measuring instrument.

In an embodiment the control system is configured for the purpose, on the basis of measurement data from a measuring instrument for a part of the mobile apparatus, of controlling the drive member for this part such that this part automatically begins to move more slowly. During for instance the transformation of the operating arm to a transport position or lifting operating position the rotation of an articulation can thus take place more and more slowly as the end position is approached. The control system can also provide for a slow rotation between main frame and sub-frame and/or for a slow movement or damping of the displacing means relative to the main frame.

In an embodiment the operating arm or the lifting device is provided with a quick change system to which an implement can be coupled. The angle of the implement is determined by the angle of the quick change system. In an embodiment the control system has available the dimensions of different implements for coupling. The control system can be configured, in the case of change of implement, to automatically calculate the limits of the positions of parts of the mobile apparatus and to control the drive members accordingly. A driver can here manually input which implement has been coupled, or the control system can be configured to detect what type of implement has been coupled. The control system can optionally request from the driver a confirmation of the type of implement before proceeding further.

In an embodiment one or more lifting devices arc mounted on the main frame to which can be coupled implements such as a wood chipper, a ground cutter, a salt-spreader, a grass mower, a pallet fork, a stabilizer shield etc. Many other implements for forestry or agriculture, construction or for landscape management can be coupled via a lifting device to the front side, the rear side or the side of the main frame. The type of lifting device for coupling an implement can be random, for instance a three-point lifting device. A power takeoff which can drive an implement can further be provided. One or more measuring instruments can determine the position of a lifting device and/or of an implement in the lifting device. In an embodiment the control system has available the dimensions of different implements for coupling in a lifting device. The control system can be configured, in the case an implement is changed, to automatically calculate the limits of the positions of parts of the mobile apparatus and to control the drive members of the lifting device accordingly. A driver can here manually input what implement has been coupled, or the control system can be configured to detect what type of implement has been coupled. The control system can optionally request from the driver a confirmation of the type of implement before proceeding further.

In an embodiment the control system is configured to combine the measurement data from the measuring instruments of the damping system with the measurement data of the position of the operating arm and the position of the implement on the operating arm, as well as of the rotation angle between the main frame and the sub-frame. The control system can hereby position and hold for instance the implement on the operating arm at a constant height relative to the surrounding area or ground level during a displacing movement. This can increase the effectiveness of the mobile apparatus on uneven terrain such as an incline, a kerb or during travel in wooded, rocky or snow-covered areas. In such a situation both the operating arm and the damping system of the mobile apparatus can be controlled simultaneously in that for instance an acceleration sensor, rotation vector sensor or gravity sensor provides data to the control system. The driver can thus be relieved of tasks so that for instance a greater mowing speed or travel speed with load in a loading shovel can be realized.

In an embodiment the mobile apparatus comprises proximity sensors which transmit measurement data to the control system to prevent collisions of the mobile apparatus and the implement on the arm or in the lifting device. Such a sensor comprises for instance a laser and/or camera which detects objects in the vicinity of the mobile apparatus. The control system of the mobile apparatus can then automatically change the movement and position of the implement in order to avoid a collision. Examples are steering clear of trees, posts and signposts along the road during mowing or moving a loading shovel upward when approaching a kerb.

In an embodiment the control system is configured to control the damping system on the basis of measurement data from an acceleration sensor, rotation vector sensor or a gravity sensor in order to give the driver a more comfortable travel performance. The control system can then be configured for the purpose, on the basis of the measured position data, of changing the position of the sub-frame using the damping system. The control system can thus be configured to tilt the sub-frame inward in bends.

In an embodiment the control system is configured to transfer control signals between the rotatable sub-frame and the main frame, and vice versa, through a so-called slip ring or via a wireless communication.

In an embodiment the mobile apparatus comprises a diesel engine, a petrol engine, a gas engine, an electric motor, a battery pack, a fuel cell or other type of motor or energy source, or a combination thereof. These components can be positioned in the rotatable sub-frame, but also in the main frame.

According to a third aspect, the invention relates to a mobile apparatus comprising a main frame with displacing means; a sub-frame connected rotatably to the main frame; an operating arm connected to the sub-frame; and a bumper system coupled to the operating arm in a transport position; which bumper system is configured and shaped to limit the impact of the operating arm on other road users in the case of collision.

According to a fourth aspect, the invention relates to a mobile apparatus comprising a main frame with displacing means; a sub-frame connected rotatably to the main frame; an operating arm connected to the sub-frame; a lifting device mounted on the main frame; and a bumper system coupled to the lifting device in a transport position; which bumper system is configured and shaped to limit the impact of the lifting device on other road users in the case of collision.

According to a fifth aspect, the invention relates to a mobile apparatus comprising a main frame; displacing means comprising at least a first and a second displacing means; a sub-frame connected rotatably to the main frame; an operating arm connected to the sub-frame; drive members configured to move the operating arm; a first damping unit between the main frame and the first displacing means for damping the movement of the main frame relative to the first displacing means; a second damping unit between the main frame and the second displacing means for damping the movement of the main frame relative to the second displacing means independently of the first damping unit; operating instruments controllable by a driver and provided close to a driver position on the sub-frame; a control system configured to receive operational data from the operating means; and configured to control the first and second damping unit in accordance with the received operational data.

Further advantageous embodiments are described in the following clauses:

1. Mobile apparatus comprising:

a main frame (10) with displacing means (21, 22, 23, 24);

a sub-frame (30) connected rotatably to the main frame;

an operating arm (40) connected to the sub-frame and comprising at least a first and a second articulation (41, 42, 43) which are connected pivotally to each other, which operating arm can be transformed from an operating position to a transport position;

drive members (51a, 51b, 52, 53) configured to move at least the first and second articulations of the operating arm;

operating instruments (60) controllable by a driver and provided close to a driver position (70) on the sub-frame;

measuring instruments (80, 81, 82, 85) configured to measure position data relating to a position of the first articulation and a position of the second articulation; and

a control system (90) configured to receive operational data from the operating means and position data from the measuring instruments; and configured to control the drive members in accordance with the received position data and the operational data.

2. Mobile apparatus according to clause 1, characterized in that the operating instruments (60) comprise a transport position command instrument which can be operated by a driver in order to move the operating arm to the transport position and which is configured to transmit a transport position command to the control system; and that the control system is configured for the purpose, after receiving a transport position command, of controlling the drive members on the basis of the position data during the movement to the transport position.

3. Mobile apparatus according to clause 2, characterized in that the control system is configured to receive position data from the measuring instruments at successive points in time during movement from the operating position to the transport position and to control the drive members in accordance with these position data received at successive points in time.

4. Mobile apparatus according to any of the foregoing clauses, characterized in that the operating arm (40) comprises at least three articulations (41, 42, 43), and that the operating arm is configured to fold the at least three articulations adjacently or against each other in the transport position.

5. Mobile apparatus according to any of the foregoing clauses, characterized in that the operating arm comprises at least a first, a second and a third articulation (41, 42, 43), wherein the third articulation is foldable against the second articulation, and these third and second articulations are together foldable along the first articulation, wherein at least one of the second and third articulations (42, 43) is locked relative to the first articulation (41) or relative to the sub-frame (30).

6. Mobile apparatus according to any of the foregoing clauses, characterized in that the measuring instruments are configured to measure position data representative of at least:

a position of the second articulation relative to the first articulation or relative to the sub-frame;

a position of the first articulation relative to the sub-frame.

7. Mobile apparatus according to clauses 4 or 5 and 6, characterized in that the measuring instruments are further configured to measure position data representative of a position of the third articulation relative to the first articulation and/or relative to the second articulation and/or relative to the sub-frame.

8. Mobile apparatus according to any of the foregoing clauses, characterized in that the measuring instruments are configured to measure position data representative of the distance between the main frame and the displacing means and/or of the rotation of the sub-frame relative to the main frame.

9. Mobile apparatus according to any of the foregoing clauses, characterized in that the measuring instruments comprise one or more of the following: a linear measuring instrument, a position or contact measuring instrument, an angle measuring instrument, a rotation measuring instrument.

10. Mobile apparatus according to any of the foregoing clauses, characterized in that the operating arm comprises a first, a second and a third articulation (41, 42, 43) for forming an articulated operating arm in an articulated operating position; that the operating arm is configured to fold the first, second and third articulations adjacently or against each other in order to transform the operating arm to a lifting arm in a lifting operating position; and that the measuring instruments comprise a measuring instrument which is configured to measure the position of the first articulation relative to the sub-frame in the articulated operating position and to measure the position of the lifting arm relative to the sub-frame in the lifting operating position.

11. Mobile apparatus according to any of the foregoing clauses, characterized in that the operating arm comprises a first, a second and a third articulation for forming an articulated operating arm in an articulated operating position; wherein the first articulation is connected to be sub-frame and wherein an implement can be mounted on the third articulation; wherein the operating arm is configured to fold the first, second and third articulations adjacently or against each other in order to transform the operating arm to a single lifting arm in a lifting operating position; wherein in the lifting operating position an implement can be mounted on the third articulation; and that the measuring instruments comprise a measuring instrument which is configured to measure the position of the implement in the articulated operating position and in the lifting operating position.

12. Mobile apparatus according to clauses 10 and 11, characterized in that the control system is configured to control the rotation of the implement in the direction of the sub-frame or the main frame in accordance with the measured position of the implement and of the first articulation or the lifting arm.

13. Mobile apparatus according to any of the foregoing clauses, characterized in that the control system is configured to allow a transformation to the transport position only when the angle between the main frame and the sub-frame lies within a predetermined range.

14. Mobile apparatus according to any of the foregoing clauses, characterized in that the measuring instruments comprise a measuring instrument (85) for measuring a value representative of the angle through which the sub-frame is rotated around a vertical axis relative to the main frame.

15. Mobile apparatus according to any of the foregoing clauses, characterized in that the control system is configured to receive rapid-coupling angle data representative of the angle between a rapid-action coupling (105) attached to the operating arm (40) and the operating arm or of the angle between the rapid-action coupling and the sub-frame or main frame or of the angle between the rapid-action coupling and a horizontal plane, and to control the movement to the transport position in accordance with the rapid-coupling angle data.

16. Mobile apparatus according to any of the foregoing clauses, characterized in that the control system is configured to allow a transformation to the transport position only when the angle between the first articulation and the sub-frame lies in a predetermined range.

17. Mobile apparatus according to any of the foregoing clauses, characterized in that the control system is configured to perform the transformation to the transport position in a first and a second phase; wherein in the first phase the operating arm is brought into a starting position in which the first articulation makes an angle lying within a predetermined range with the sub-frame and the second articulation makes an angle lying in a predetermined range with the first articulation; and wherein in the second phase the operating arm is moved to the transport position.

18. Mobile apparatus according to any of the foregoing clauses, characterized in that in the transport position the first articulation lies substantially adjacently or against the second articulation.

19. Mobile apparatus according to any of the foregoing clauses, characterized in that the operating arm comprises a first, a second and a third articulation (41, 42, 43), wherein in the transport position the third articulation is folded against the second articulation, and these third and second articulations are together folded along the first articulation, and the operating arm thus folded together is oriented obliquely downward from the sub-frame and extends between the displacing means.

20. Mobile apparatus according to any of the foregoing clauses, characterized in that the control system is configured, during transformation of the operating arm to the transport position and vice versa, to control only the articulations of the operating arm, and optionally an articulation lock, and no other movements of the mobile apparatus can be controlled.

21. Mobile apparatus according to any of the foregoing clauses, characterized in that the control system is configured to control the drive members such that the speed at which the second articulation moves relative to the first articulation and/or the third articulation relative to the second articulation is modified in accordance with the position data.

22. Mobile apparatus according to any of the foregoing clauses, characterized in that the control system is configured to control the drive members such that a drive member of the second articulation and/or a drive member of the third articulation continues to generate force after reaching an end point in order to hold the articulation in position during locking and/or unlocking of one of the articulations; and/or that a measuring instrument is provided in order to determine whether locking components of an articulation are in the correct position before locking/unlocking is performed.

23. Mobile apparatus according to any of the foregoing clauses, characterized in that the mobile apparatus comprises a lifting device (170) which is mounted on the main frame, and that the measuring instruments comprise a measuring instrument configured to measure the position of the lifting device, and that the control system is configured to avoid collisions between the lifting device and other parts of the mobile apparatus on the basis of the measured position of the lifting device.

24. Mobile apparatus according to any of the foregoing clauses, characterized in that the control system (90) comprises a bus system.

25. Mobile apparatus comprising:

a main frame (10);

displacing means (21, 22, 23, 24);

a sub-frame (30) connected rotatably to the main frame;

an operating arm (40) connected to the sub-frame;

drive members (51a, 51b, 52, 53) configured to move the operating arm;

a damping system (110) between the main frame and at least one displacing means for damping the movement of the main frame relative to the displacing means;

operating instruments (60) controllable by a driver and provided close to a driver position on the sub-frame;

a control system (90) configured to receive operational data from the operating means; and configured to block the damping system in accordance with the received operational data.

26. Mobile apparatus according to clause 25, characterized in that the damping system (110) is active between the main frame and all displacing means.

27. Mobile apparatus according to clause 25 or 26, further comprising at least one of the following:

a measuring instrument (87) between at least one displacing means and the main frame; a

measuring instrument between all displacing means and the main frame.

28. Mobile apparatus according to clause 27, characterized in that the one or more measuring instruments comprise one or more of the following: a linear measuring instrument, a position or contact measuring instrument, an angle measuring instrument, a rotation measuring instrument.

29. Mobile apparatus according to either of the clauses 27 or 28, characterized in that the or each measuring instrument (87) is integrated into the damping system (110).

30. Mobile apparatus according to any of the clauses 25-29, characterized in that the damping system comprises at least one damping unit (113) comprising a cylinder or a bellows under pressure.

31. Mobile apparatus according to any of the clauses 25-30, characterized in that the damping system comprises at least one damping unit (113) with associated damping characteristic, and that the control system (90) is configured to set the or each damping characteristic.

32. Mobile apparatus according to any of the clauses 25-31, characterized in that the operating arm (40) comprises at least three articulations (41, 42, 43), and that the operating arm is configured to fold the at least three articulations adjacently or against each other and/or lock them relative to each other in the transport position.

33. Mobile apparatus according to any of the clauses 25-32, characterized in that the damping system comprises a plurality of damping units (113) and that the control system (90) is configured to block one or more of the damping units in a blocked position, which blocked position can for instance be a high blocked position, in which the main frame is located in a highest position relative to the displacing means, a low blocked position, in which the main frame is located in a lowest position relative to the displacing means, or a blocked intermediate position located between the highest and lowest position.

34. Mobile apparatus according to any of the clauses 25-33, characterized in that the control system is configured to block the damping system (110) in accordance with angle data representative of the rotation of the sub-frame relative to the main frame.

35. Mobile apparatus according to any of the clauses 25-34, characterized in that the damping system is of the independent suspension type.

36. Mobile apparatus according to any of the clauses 25-35, characterized in that the damping system (110) comprises a damping unit (113) between a first axle (141) of the displacing means and the main frame.

37. Mobile apparatus according to clause 36, further comprising a support structure provided on the main frame, which support structure is provided with a gear ring or rotary bearing for the sub-frame, characterized in that one or more arms (120; 111, 112; 131, 132) which are connected pivotally at their outer ends are provided between the first axle and the support structure.

38. Mobile apparatus according to clause 37, wherein the one or more arms comprise a first and a second arm (131, 132) which extended in the direction of travel, wherein an outer end of the first arm (131) is positioned close to a first displacing means (21) on the first axle and wherein the other outer end of the first arm is positioned close to a first outer side (18) of the support structure (15); and wherein an outer end of the second arm (132) is positioned close to a second displacing means (23) on the first axle (141) and wherein the other outer end of the second arm is positioned close to a second outer side (19) of the support structure (15).

39. Mobile apparatus according to clause 37 or 38, characterized in that the mobile apparatus comprises a second axle (142) which is connected to displacing means (22, 24) and that one or more arms which are connected pivotally at their outer ends are provided between the second axle (142) and the support structure (15).

40. Mobile apparatus according to clause 36, further comprising a support structure (15) provided on the main frame, which support structure is provided with a gear ring or rotary bearing for the sub-frame, characterized in that the first axle (141) is coupled by a V-shaped structure (150) to the support structure, wherein the V-shaped structure is configured to realize a lateral stabilization of the first axle relative to the support structure.

41. Mobile apparatus according to clause 40, characterized in that the main frame comprises a second axle (142) and that the second axle (142) of the main frame is provided with one or more V-shaped structures (150) between the second axle (142) and the support structure (15).

42. Mobile apparatus according to any of the clauses 36-41, characterized in that at least a transverse arm (120) oriented parallel to the first axle (141) is active between the first axle and the main frame in order to stabilize the first axle laterally relative to the main frame.

43. Mobile apparatus according to any of the clauses 25-42, characterized in that the damping system comprises a suspension system with a leaf spring.

44. Mobile apparatus according to any of the clauses 25-43, further comprising a measuring instrument for measuring position data representative of the position of the main frame and/or the sub-frame, wherein the control system is configured to control the damping system in accordance with the measured position data.

45. Mobile apparatus according to any of the foregoing clauses, characterized in that the damping system comprises one or more double wishbone suspensions between the main frame and the displacing means.

46. Mobile apparatus according to any of the foregoing clauses, characterized in that the control system (90) is configured to be coupled to one or more of the following measuring instruments: a gyroscope, a rotation vector sensor, a rotation sensor, a gravity sensor, an acceleration sensor, a compass, a roll sensor, a yaw sensor, a pitch sensor.

47. Mobile apparatus according to any of the foregoing clauses, characterized in that a measuring instrument for an anti-lock braking system controls the braking force of at least a spring-mounted and/or damped displacing means.

48. Mobile apparatus according to any of the foregoing clauses, characterized in that a measuring instrument for an anti-lock braking system on/at the main frame transmits signals via the control system to the operating instruments or to a warning system on the main frame.

49. Mobile apparatus according to any of the foregoing clauses, characterized in that the control system is configured to be coupled to an external computer unit which has available at least one of the following measuring instruments: a gyroscope, a rotation vector sensor, a rotation sensor, a gravity sensor, an acceleration sensor, a compass, a roll sensor, a yaw sensor, a pitch sensor.

50. Mobile apparatus according to clause 44, characterized in that the control system is configured to change or hold the position of the sub-frame as level as possible using the damping system on the basis of the measured position data.

51. Mobile apparatus according to clause 44 or 50, characterized in that the control system is configured to limit, on the basis of the measured position data, variations in the height of the implement relative to ground level or relative to a set line during displacement of the mobile apparatus.

52. Mobile apparatus according to any of the clauses 25-51, characterized in that a lifting device (170), and optionally a power takeoff (160), is connected to at least one displacing means or to an axle coupled to a displacing means and is thereby not spring-mounted and/or damped relative to at least said displacing means.

53. Mobile apparatus according to any of the clauses 25-51, characterized in that a lifting device (170), and optionally a power takeoff (160), is connected to a spring-mounted part of the main frame and is thereby spring-mounted and/or damped relative to at least one displacing means or an axle with displacing means.

54. Mobile apparatus according to clause 52, characterized in that a lifting device, and optionally a power takeoff, is connected to a spring-mounted part of the main frame with a supporting part running under an axle or under a displacing means suspension.

55. Mobile apparatus, comprising:

a main frame (10) with displacing means (20);

a sub-frame (30) connected rotatably to the main frame;

an operating arm connected to the sub-frame; and

a bumper system (200) coupled to the operating arm (40) in a transport position; which bumper system is configured and shaped to limit the impact of the operating arm on other road users in the case of collision.

56. Mobile apparatus, comprising:

a main frame (10) with displacing means (20);

a sub-frame (30) connected rotatably to the main frame;

an operating arm connected to the sub-frame;

a lifting device (170) mounted on the main frame; and

a bumper system (210) coupled to the lifting device in a transport position; which bumper system is configured and shaped to limit the impact of the operating arm on other road users in the case of collision.

57. Mobile apparatus according to clause 55, wherein the operating arm comprises at least a first articulation and a last articulation to which an implement is connectable, characterized in that in the transport position the bumper system is coupled to the last articulation, optionally via a quick change system (105) or via a rotating and/or tilting part.

58. Mobile apparatus according to clause 57, characterized in that the bumper system (200) comprises a bumper which extends from the displacing means as far as the last articulation.

59. Mobile apparatus according to any of the clauses 55, 57 or 58, characterized in that the bumper system is formed by coupling a bumper to an implement such as a loading shovel or excavator bucket or other type of implement.

60. Mobile apparatus according to any of the clauses 55, 57, 58 or 59, further comprising a lifting device (170) mounted on the main frame, characterized in that the lifting device is coupled to a second bumper system (210).

61. Mobile apparatus according to clause 60, characterized in that the lifting device is coupled to the second bumper system (210) on a rear side of the mobile apparatus.

62. Mobile apparatus according to any of the clauses 55-61, characterized in that the operating arm comprises at least three articulations and that the operating arm is configured to fold the at least three articulations adjacently or against each other in the transport position.

63. Mobile apparatus according to any of the foregoing clauses, characterized in that the displacing means are wheels or caterpillars.

64. Mobile apparatus according to any of the foregoing clauses, characterized in that the operating arm is connected by means of a horizontal and/or vertical rotation point to the sub-frame.

65. Mobile apparatus, comprising:

a main frame (10);

displacing means (21, 22, 23, 24) comprising at least a first and a second displacing means;

a sub-frame (30) connected rotatably to the main frame;

an operating arm (40) connected to the sub-frame;

drive members (51a, 51b, 52, 53) configured to move the operating arm;

a first damping unit (113) between the main frame and the first displacing means for damping the movement of the main frame relative to the first displacing means;

a second damping unit (113) between the main frame and the second displacing means for damping the movement of the main frame relative to the second displacing means independently of the first damping unit;

operating instruments (60) controllable by a driver and provided close to a driver position on the sub-frame;

a control system (90) configured to receive operational data from the operating means; and

configured to control the first and second damping units in accordance with the received operational data.

66. Mobile apparatus according to clause 65, further comprising at least one of the following: a first measuring instrument (87) for measuring a position of the main frame relative to the first displacing means; a second measuring instrument for measuring a position of the main frame relative to the second displacing means.

67. Mobile apparatus according to clause 66, characterized in that the first measuring instrument (87) is integrated into the first damping unit (113) and that the second measuring instrument (87) is integrated into the second damping unit (113).

68. Mobile apparatus according to any of the clauses 65-67, characterized in that the first and second damping units (113) comprise a cylinder or a bellows under pressure.

69. Mobile apparatus according to any of the clauses 65-68, characterized in that the first and second damping units (113) have an associated first and second damping characteristic, and that the control system (90) is configured to set the first and second damping characteristic.

70. Mobile apparatus according to any of the clauses 65-69, characterized in that the operating arm (40) comprises at least three articulations (41, 42, 43) and that the operating arm is configured to fold the at least three articulations adjacently or against each other and/or lock them relative to each other in the transport position.

71. Mobile apparatus according to any of the clauses 65-70, characterized in that the control system (90) is configured to block the first and/or the second damping unit in a blocked position, which blocked position can for instance be a high blocked position, in which the main frame is located in a highest position relative to the displacing means, a low blocked position, in which the main frame is located in a lowest position relative to the displacing means, or a blocked intermediate position located between the highest and lowest position.

72. Mobile apparatus according to any of the clauses 65-71, characterized in that the first displacing means is part of front displacing means and that the second displacing means is part of rear displacing means.

73. Mobile apparatus according to clause 72, characterized in that the first damping unit (113) is located between a first axle (141) which is connected to the front displacing means and the main frame, and that the second damping unit (113) is located between a second axle (142) which is connected to the rear displacing means and the main frame.

74. Mobile apparatus according to clause 3, further comprising a support structure (15) provided on the main frame, which support structure is provided with a gear ring or rotary bearing for the sub-frame, characterized in that the first axle (141) is coupled by a V-shaped structure (150) to the support structure, wherein the V-shaped structure is configured to realize a lateral stabilization of the first axle relative to the support structure.

75. Mobile apparatus according to any of the clauses 65-74, further comprising a measuring instrument for measuring position data representative of the position of the main frame and/or the sub-frame, wherein the control system is configured to control the first and the second damping unit in accordance with the measured position data.

76. Mobile apparatus according to any of the clauses 65-75, characterized in that the first and second damping units comprise a double wishbone suspension.

### BRIEF DESCRIPTION OF THE FIGURES

The above stated and other advantageous features and objects of the invention will become more apparent, and the invention better understood, on the basis of the following detailed description when read in combination with the accompanying drawings, in which:

FIG. 1A is a side view of a first embodiment of a mobile apparatus in a first articulated operating position;

FIG. 1B is a side view of the first embodiment in a second articulated operating position;

FIG. 1C is a side view of the first embodiment in a first lifting operating position;

FIG. 1D is a side view of the first embodiment in a second lifting operating position;

FIG. 1E is a side view of the first embodiment in a transport position, with bumper system;

FIG. 1F is a side view of an end part 31 of the sub-frame 30 which shows how the rotation point between the third and the second articulation of the first embodiment moves during folding-up of the operating arm;

FIG. 1G is a top view of the first embodiment in the transport position with a bumper mounted on the operating arm and a bumper mounted on the lifting device;

FIG. 2A is a schematic side view of a second embodiment of a mobile apparatus in a transport position, wherein the displacing means comprise caterpillars;

FIG. 2B is a schematic side view of a part of the second embodiment during the transformation from operating arm 40 to the transport position;

FIG. 3A is a schematic side view of a third embodiment of a mobile apparatus in an operating position, wherein the displacing means comprise caterpillars;

FIG. 3B is a schematic side view of the third embodiment in the transport position;

FIG. 3C is a schematic top view of the third embodiment in the transport position;

FIGS. 4A-4D show four variants of measuring instruments for measuring the position of a first articulation 41 relative to a second articulation 42;

FIG. 5 shows a diagram of an embodiment of the control system 90 and the components connected to the control system;

FIG. 6 is a schematic front view of an embodiment of a mobile apparatus with a double wishbone suspension of the displacing means;

FIG. 7 is a schematic top view of an embodiment of a mobile apparatus with a double wishbone suspension of the displacing means and with a lifting device and power takeoff;

FIGS. 8A and 8B show schematically a front and top view of an embodiment of a mobile apparatus with a damping system 110 per axle;

FIG. 9 is a schematic side view of an embodiment of a mobile apparatus with a damping system with leaf springs:

FIGS. 10A, 10B and 10C show schematically a side view, a top view and a partial side view of embodiments of a mobile apparatus with a damping system 110 with additional longitudinal arms 131, 132;

FIG. 10D is a schematic top view of a variant of the embodiment of FIG. 10B;

FIG. 10E is a schematic side view similar to the side view of FIG. 10C in which a mobile apparatus with damping system is positioned on an incline;

FIG. 10F is a schematic side view similar to the side view of FIG. 10C in which a mobile apparatus with damping system and caterpillar tracks is positioned on an incline;

FIGS. 11A and 11B show schematically a top and side view of an embodiment of a mobile apparatus with lifting device and power takeoff which co-displace with an axle;

FIGS. 12A and 12B show schematically a top and side view of an embodiment of a mobile apparatus with lifting device and power takeoff which co-displace with the main frame;

FIG. 13 shows a diagram of an embodiment of the control system 90 and the components connected to the control system; and

FIG. 14 shows an embodiment of a damping unit.

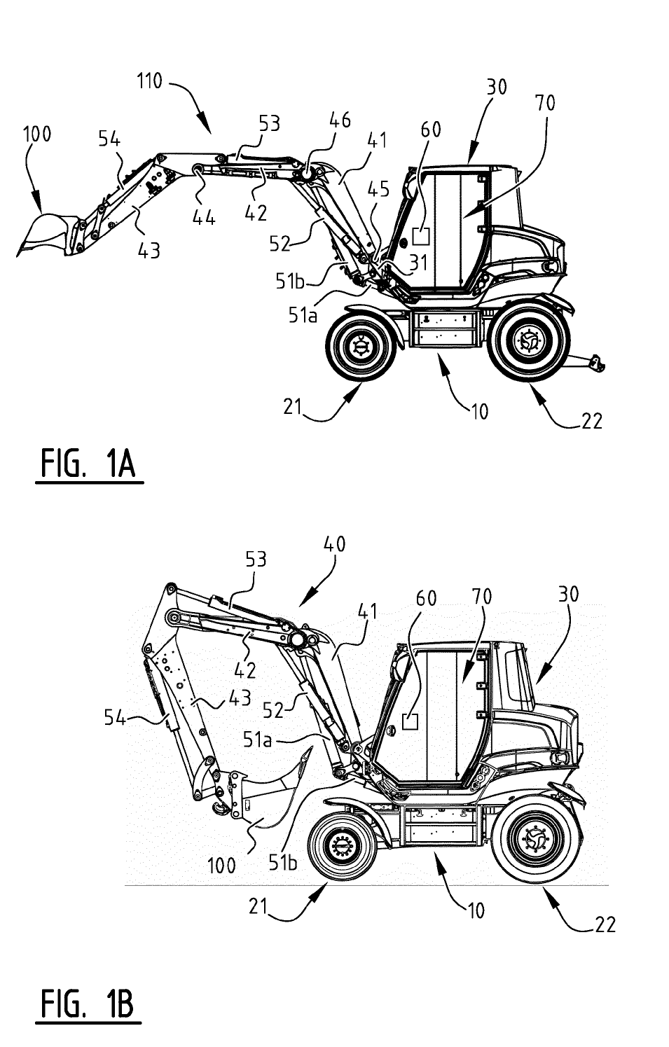

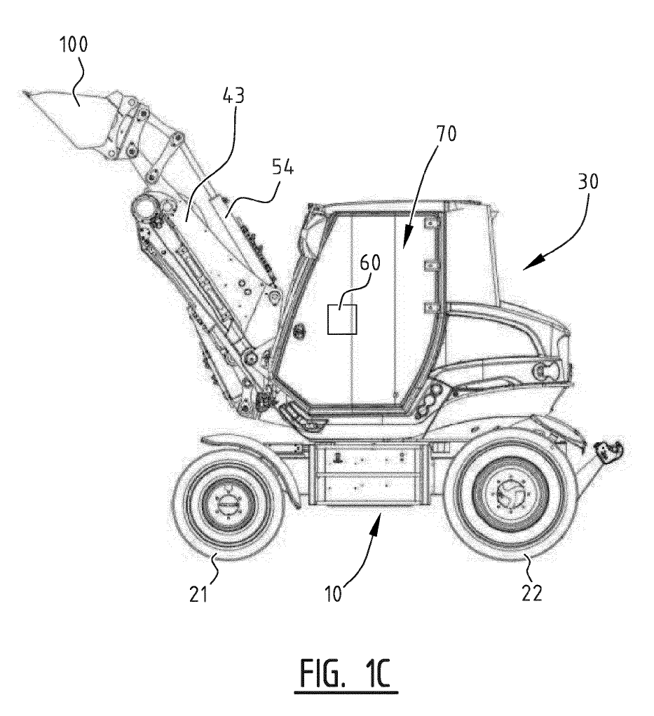

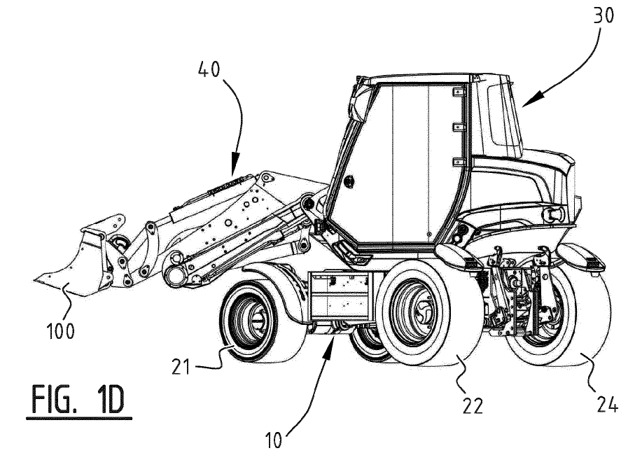

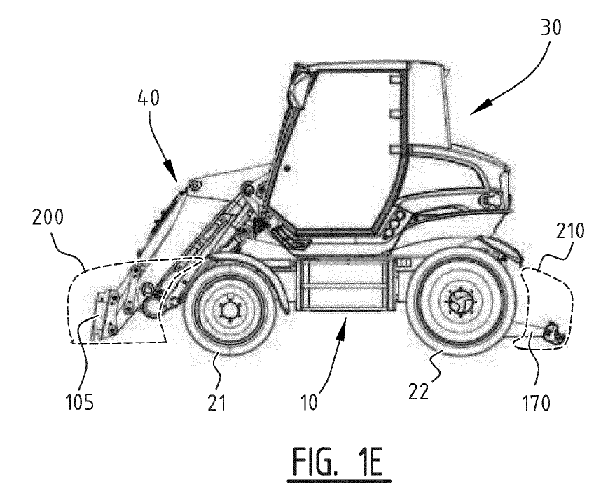

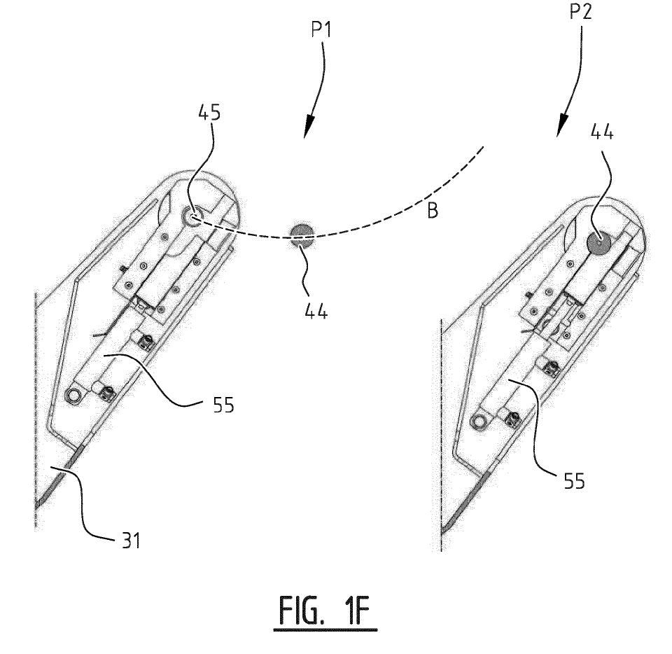

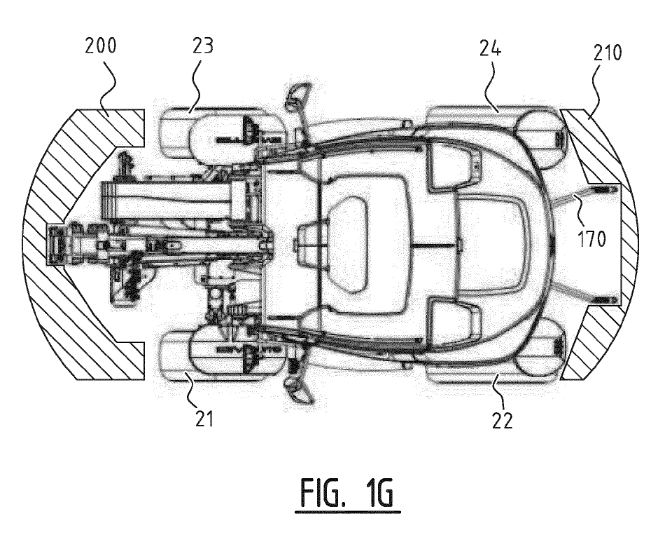

FIGS. 1A-1G illustrate a first embodiment of a mobile apparatus. The mobile apparatus comprises a main frame 10 with displacing means 21, 22, 23, 24, here wheels, a sub-frame 30 connected rotatably to the main frame and an operating arm 40 connected to sub-frame 30. Operating arm 40 comprises a first articulation 41, a second articulation 42 and a third articulation 43 which are connected pivotally to each other, see rotation point 44 between third articulation 43 and second articulation 42 and rotation point 46 between second articulation 42 and first articulation 41. First articulation 41 is connected around rotation point 45 to sub-frame 30. Operating arm 40 can be transformed from an operating position (FIGS. 1A-1D) to a transport position (FIGS. 1E and 1G). The mobile apparatus further comprises first, second and third drive members 51a, 51b; 52; 53 configured to move respectively the first articulation relative to the sub-frame, the second articulation relative to the first and the third articulation relative to the second.

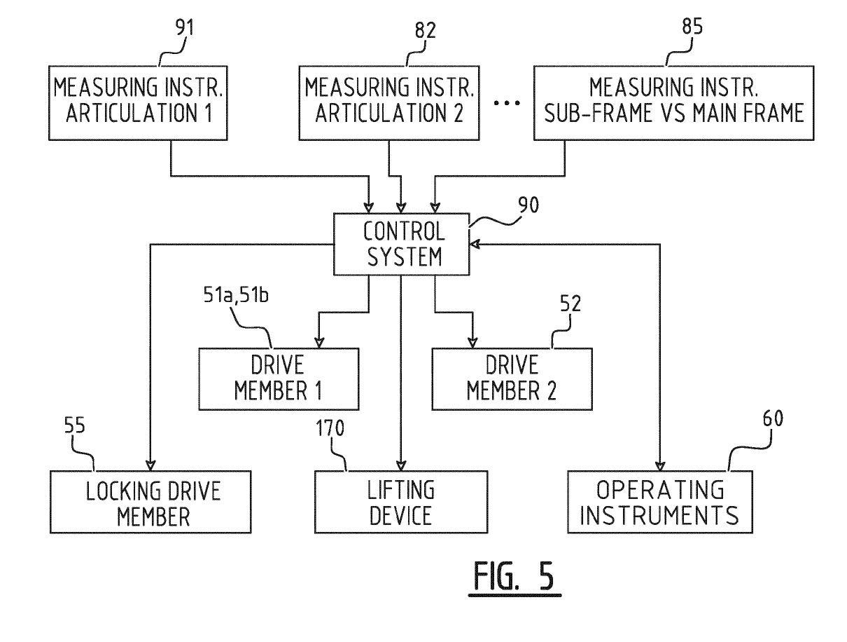

The first embodiment further comprises operating instruments 60 controllable by a driver and provided close to a driver position 70 on sub-frame 30, and measuring instruments 81, 82, 83 (not shown in FIGS. 1A-1G, but shown in FIG. 5) which are configured to measure position data relating to a position of the first articulation and a position of the second articulation; and a control system 90 (not shown in FIGS. 1A-1G, but shown in FIG. 5) which is configured to receive operational data from operating means 60 and position data from measuring instruments 81, 82, 83; and which is configured to control the drive members in accordance with the received position data and the operational data. An embodiment thereof is shown in FIG. 5.

Operating instruments 60 can comprise a transport position command instrument which can be operated by a driver for the purpose of moving the operating arm to the transport position and which is configured to transmit a transport position command to the control system; and control system 90 can be configured to control the drive members 51a, 51b; 52, 53, after receiving a transport position command, on the basis of the position data during movement to the transport position. A drive member 55 for locking the articulations (see FIG. 1F) and a drive member 54 for controlling the position of an implement relative to third articulation 43 can be controlled by control system 90.

Measuring instruments 81, 82, 83, 85 etc. can be configured to measure position data representative of a position of the second articulation relative to the first articulation or relative to the sub-frame; and/or a position of the first articulation relative to the sub-frame; and/or position data representative of a position of the third articulation relative to the first articulation and/or relative to the second articulation and/or relative to the sub-frame; and/or position data representative of the distance between the main frame and the displacing means and/or of the rotation of the sub-frame relative to the main frame.

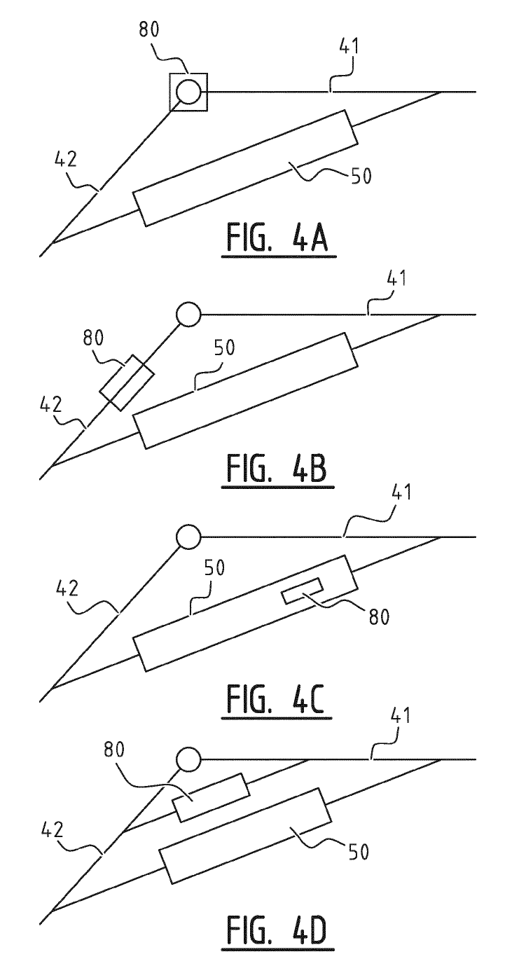

Measuring instruments 81, 82, 83, 85 etc. can comprise one or more of the following: a linear measuring instrument 80 (for instance an MTS sensor), wherein this measuring instrument is provided in a drive member 50 between a first articulation 41 and a second articulation 42, see FIG. 4C, or outside it, see FIG. 4D; an angle measuring instrument 80, see FIG. 4B, for measuring the inclination of second articulation 42; a rotation measuring instrument 80, see FIG. 4A, for measuring the rotation of first articulation 41 relative to second articulation 42; a position or contact measuring instrument. In the embodiment of FIG. 1A measuring instruments can for instance be provided in one or more of the drive members 51a, 51b; 52, 53, 54, 55.

The operating arm can form an articulated operating arm 40 in an articulated operating position; wherein the first articulation is connected to the sub-frame and wherein an implement 100 can be mounted on the third articulation; wherein the operating arm is configured to fold the first, second and third articulations adjacently or against each other in order to transform operating arm 40 to a single lifting arm in a lifting operating position; wherein in the lifting operating position an implement 100 can be mounted on the third articulation. The measuring instruments can comprise a measuring instrument configured to measure the position of the first articulation relative to the sub-frame in the articulated operating position and to measure the position of the lifting arm relative to the sub-frame in the lifting operating position, and/or comprise a measuring instrument configured to measure the position of the implement in the articulated operating position and in the lifting operating position.

Control system 90 can be configured

to receive position data from measuring instruments 81, 82, 83 at successive points in time during the movement from the operating position to the transport position and to control the drive members 51-55 in accordance with these position data received at successive points in time; and/or

to fold the at least three articulations adjacently or against each other in the transport position and to lock them relative to each other; and/or

to fold third articulation 43 against second articulation 42 and to fold this third and second articulation together along first articulation 41, wherein at least one of the second and third articulations 42, 43 is locked relative to first articulation 41 or relative to sub-frame 30; and/or

to control the rotation of the implement in the direction of the sub-frame or the main frame in accordance with the measured position of the implement and of the first articulation or the lifting arm;

to allow a transformation to the transport position only as soon as the angle between the main frame and the sub-frame lies within a predetermined range; and/or

to receive rapid-coupling angle data representative of the angle between a rapid-action coupling 105 attached to operating arm 40 and the operating arm and to control the movement to the transport position in accordance with the rapid-coupling angle data; and/or

to allow a transformation to the transport position only when the angle between the first articulation and the sub-frame lies in a predetermined range; and/or

to perform the transformation to the transport position in a first and a second phase; wherein in the first phase the operating arm is brought into a starting position in which the first articulation makes an angle lying within a predetermined range with the sub-frame and the second articulation makes an angle lying within a predetermined range with the first articulation; and wherein in the second phase the operating arm is moved to the transport position. Note that the first phase can also take place manually by a driver in order to avoid the operating arm colliding with other elements in the surrounding area; and/or

to control only the articulations of the operating arm and optionally an articulation lock during transformation of the operating arm to the transport position, and vice versa, and no other movements of the mobile apparatus can be controlled; and/or

to control the drive members such that the speed at which the second articulation moves relative to the first articulation and/or the third articulation relative to the second articulation is modified in accordance with the position data; and/or

to control the drive members such that a drive member of second articulation 42 and/or a drive member of third articulation 43 continues to generate force after reaching an end point in order to hold the articulation in position during locking and/or unlocking of one of the articulations. See also FIG. 1F: during the transformation of the rotation point 44 (with a pin) moves to rotation point 45 along a path B, wherein the movement slows as rotation point 44 with pin approaches rotation point 45 and the associated drive member continued to generate force during locking by locking drive member 55. Control system 110 can be configured for this purpose to control drive member 52 of second articulation 42 and/or drive member 53 of third articulation 43 such that they continue to generate force after reaching the end point in order to hold articulations 42, 43 in position during locking and/or unlocking of the articulations. A measuring instrument (not shown) can further be provided in order to assess whether pin 44 coincides at the correct location with rotation point 45 before unlocking and movement of the second and/or third articulation in articulated position or, conversely, locking and subsequent movement of the second and/or third articulation in transport or single operating arm position can be initiated.

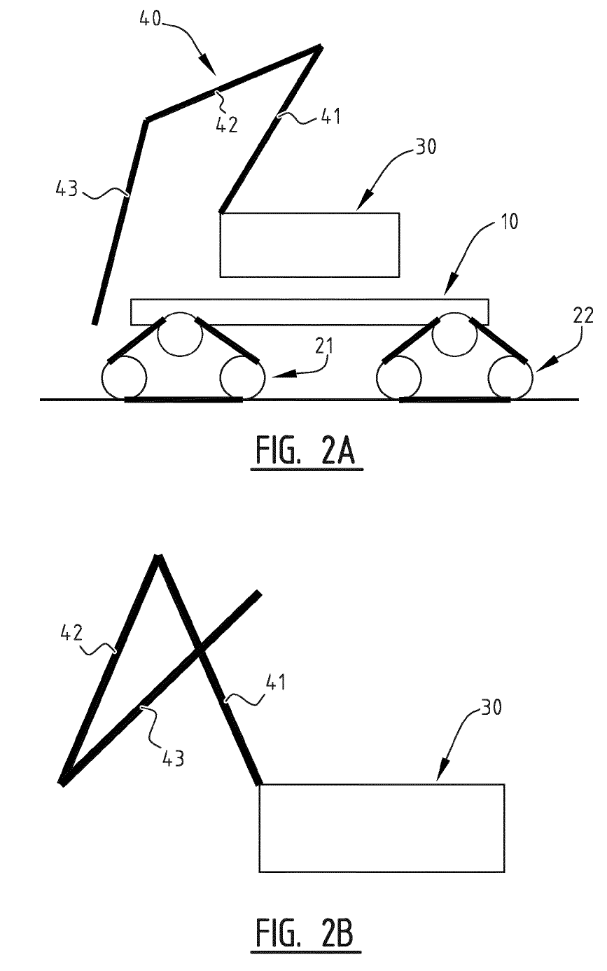

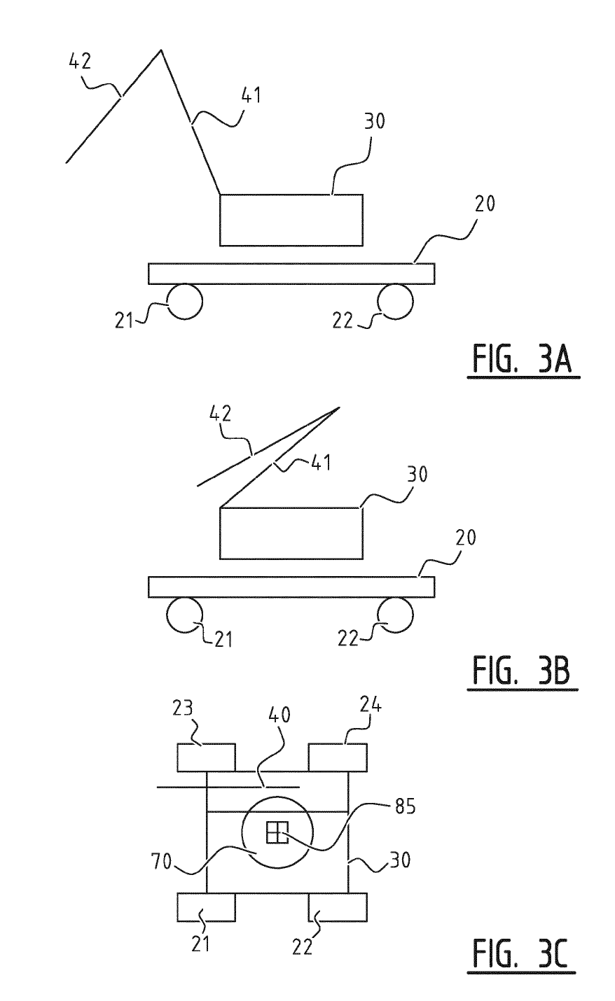

The measuring instruments can comprise a measuring instrument 85 for measuring a value representative of the angle through which the sub-frame is rotated round a vertical axis relative to the main frame, see also FIG. 5 and FIG. 3C. In the transport position of the first embodiment (FIG. 1E) the third articulation is folded against the second articulation, and these third and second articulations are together folded along the first articulation, and the operating arm thus folded together is oriented obliquely downward from the sub-frame and arm 40 is situated between the displacing means. In the variant of FIGS. 2A and 2B the transport position (FIG. 2A) is a non-folded position of operating arm 40. In the variant of FIGS. 3A and 3B and 3C first articulation 41 is folded in the transport position against second articulation 42 and the folded operating arm 40 is oriented obliquely upward over sub-frame 30 (see FIGS. 3B and 3C).

The mobile apparatus can further comprise a lifting device 170 which is mounted on main frame 10, the measuring instruments can comprise a measuring instrument configured to measure the position of lifting device 170 and control system 90 can be configured to avoid collisions between lifting device 170 and other parts of the mobile apparatus on the basis of the measured position of the lifting device.

Control system 90 can comprise a bus system.

FIGS. 1E and 1G illustrate a mobile apparatus in a transport position. The mobile apparatus comprises a main frame 10 with displacing means 20; a sub-frame 30 connected rotatably to the main frame; an operating arm 40 connected to sub-frame 30; a lifting device 170, a first bumper system 200 coupled to operating arm 40; and a second bumper system 210 coupled to lifting device 170. First bumper system 200 is configured and shaped in order to limit the impact of operating arm 40 on other road users in the case of collision. Second bumper system 210 is configured and shaped to limit the impact of the lifting device on other road users in the case of collision. First bumper system 200 is coupled to the last articulation of operating arm 40 via a quick change system 105 which is mounted via a parallelogram linkage on an outer end of the last articulation of operating arm 40. According to another variant, a rotating and/or tilting part, for instance a so-called tilt rotator, can be used. First bumper system 200 comprises a bumper which extends from the displacing means as far as the last articulation of operating arm 40. Lifting device 170 is coupled to second bumper system 210 on a rear side of the mobile apparatus. As described above, operating arm 40 has three articulations and operating arm 40 is configured to fold the at least three articulations adjacently or against each other in the transport position. First bumper system 200 can then be attached after operating arm 40 has been brought into the transport position.

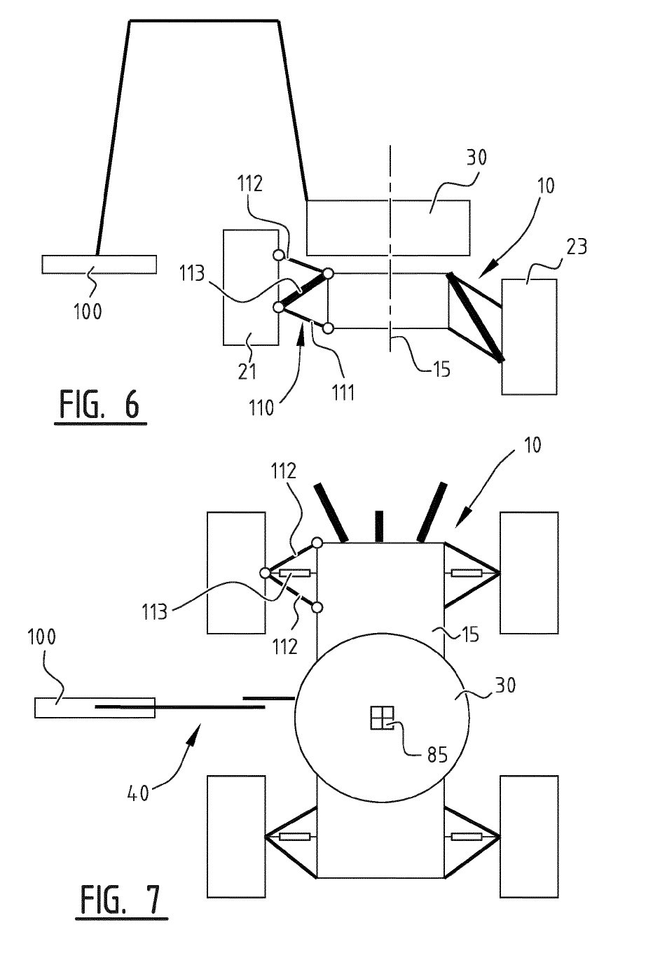

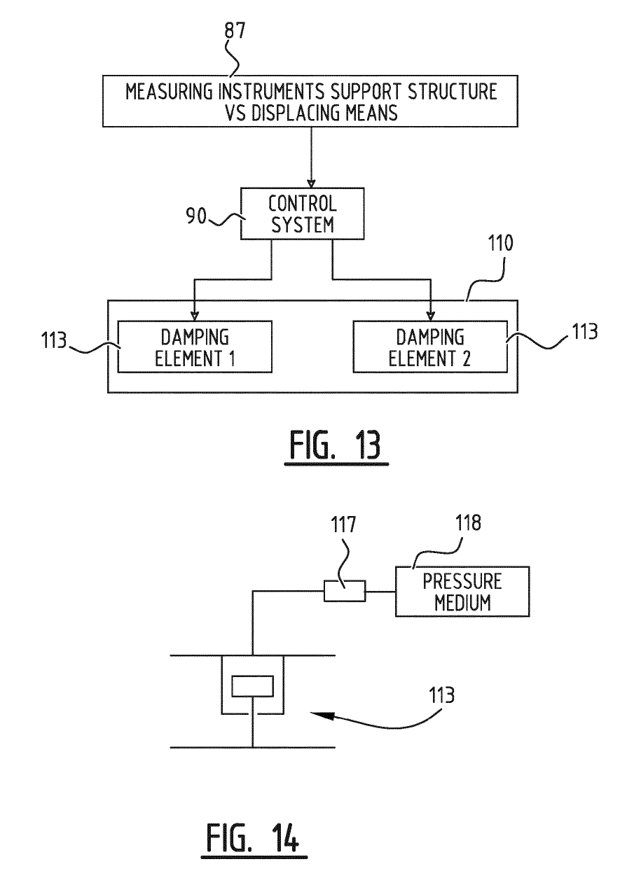

FIGS. 6-12 show a mobile apparatus comprising: a main frame 10; displacing means 21, 22, 23, 24; a sub-frame 30 connected rotatably to the main frame; an operating arm 40 connected to the sub-frame and comprising at least a first and a second articulation connected pivotally to each other; a damping system 110 between the main frame and at least one displacing means for damping the movement of the main frame relative to the displacing means; operating instruments (not shown) controllable by a driver and provided close to a driver position on the sub-frame; a control system (not drawn in FIGS. 6-12 but shown in FIG. 13) which is configured to receive operational data from the operating means; and which is configured to block the damping system in accordance with the received operational data. Damping system 110 is active between the main frame and all displacing means. The mobile apparatus preferably comprises a measuring instrument 87 between at least one displacing means and the main frame and/or a measuring instrument 87 between all displacing means and the main frame, see also FIG. 13. The one or more measuring instruments can comprise one or more of the following: a linear measuring instrument, a position or contact measuring instrument, an angle measuring instrument, a rotation measuring instrument. A measuring instrument 87 can be integrated into damping system 110. Damping system 110 comprises at least one damping unit 113, also referred to as suspension unit, which for instance comprises a cylinder or a bellows under pressure. FIG. 14 shows a damping unit 113 with a cylinder which is placed under pressure by a pressure medium 118 via a controllable valve 117 for the purpose of controlling or blocking the damping cylinder. Damping unit 113 typically has an associated damping characteristic, and control system 90 can be configured to set the or each damping characteristic. The damping system can comprise a plurality of damping units 113 and control system 90 can be configured to block one or more of the damping units in a blocked position, which blocked position can be for instance a high blocked position, in which the main frame is located in a highest position relative to the displacing means, a low blocked position, in which the main frame is located in a lowest position relative to the displacing means, or a blocked intermediate position located between the highest and lowest positions.

In the embodiment of FIGS. 6 and 7 damping system 110 comprises a double wishbone suspension 110 for each displacing means. The double wishbone suspension 110 comprises a damping unit 113 and a number of pivot arms 111, 112.

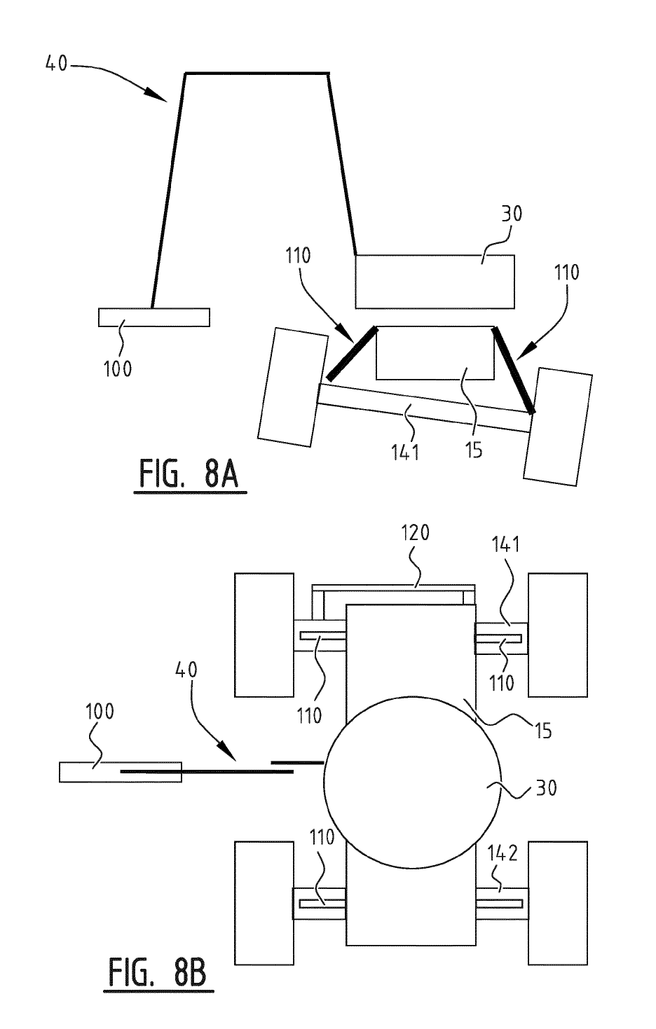

In the variant of FIGS. 8A and 8B damping system 110 comprises a damping unit 113 between a first axle 141 of the displacing means and the main frame. The mobile apparatus comprises a support structure 15 provided on the main frame, which support structure is provided with a gear ring or rotary bearing for the sub-frame, and provided between first axle 141 and support structure 15 is an arm 120 which is pivotally connected at its outer ends. Transverse arm 120 is active between first axle 141 and the main frame in order to stabilize first axle 141 laterally relative to the main frame.

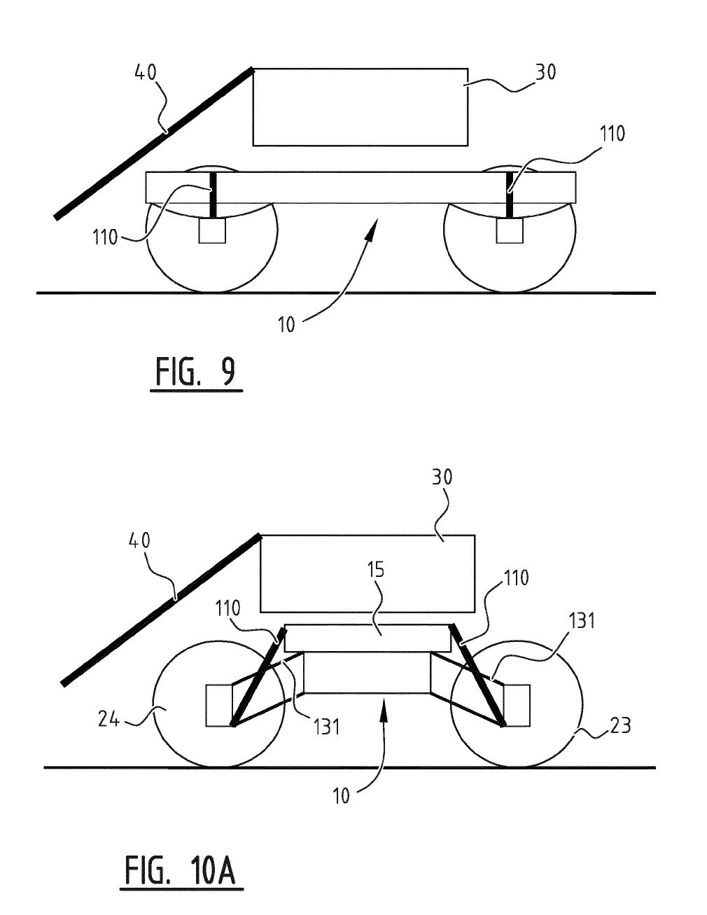

In the variant of FIG. 9 leaf springs are used in damping system 110.

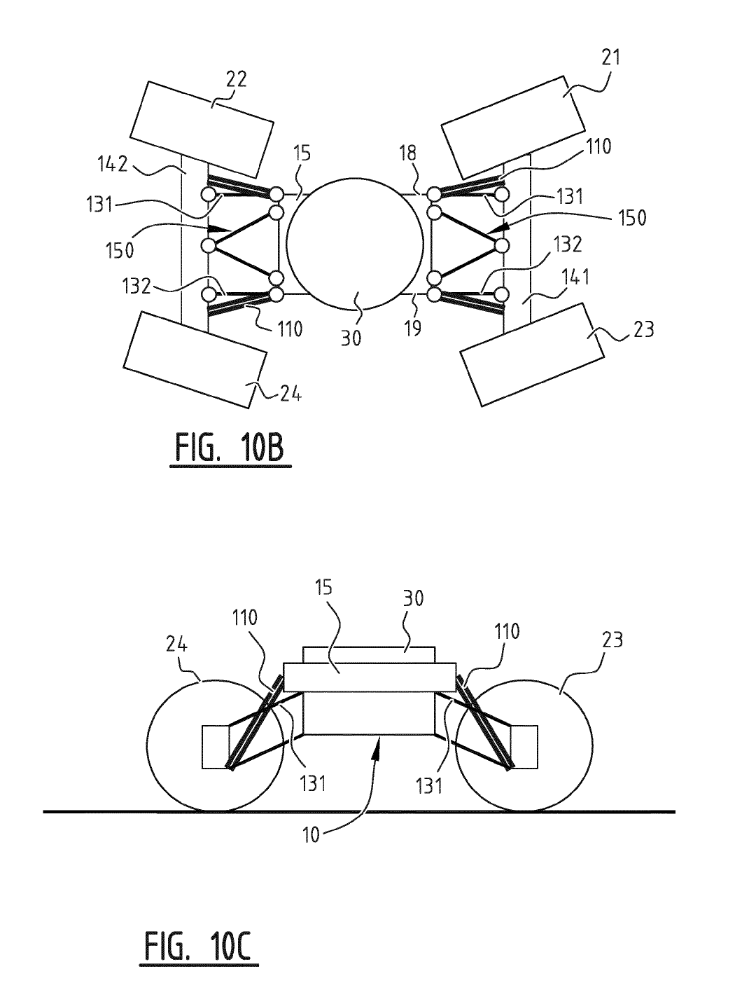

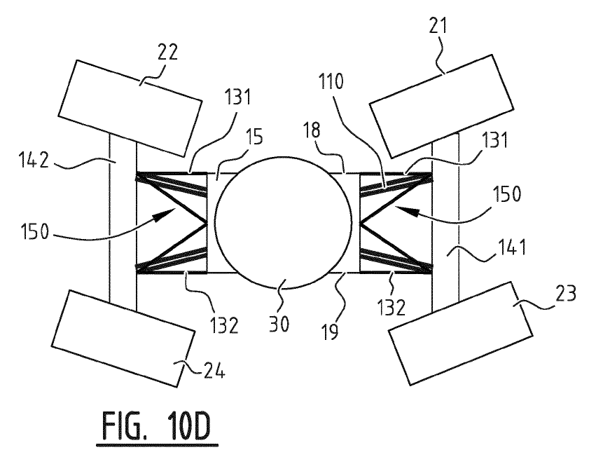

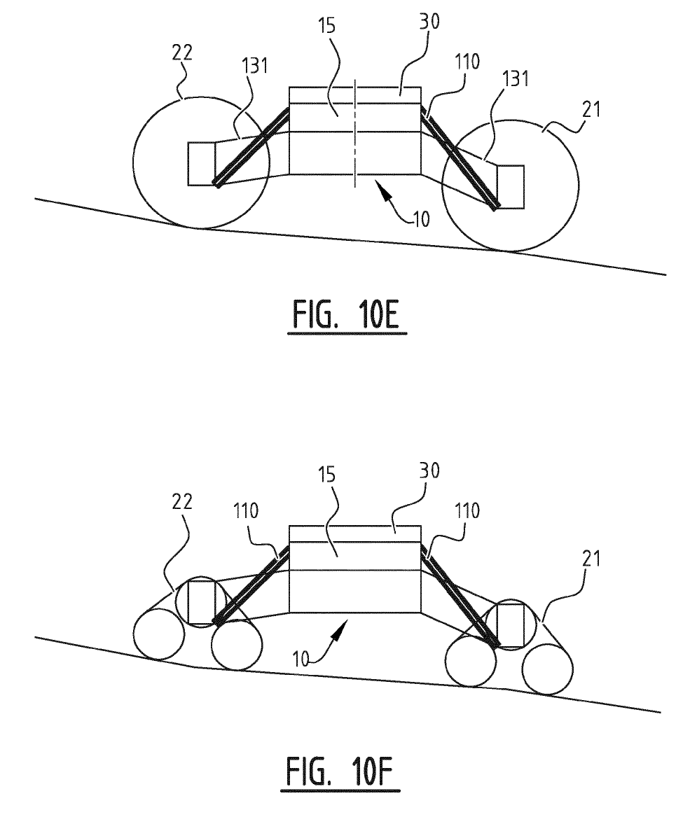

Provided in the variant of FIGS. 10A-10C are a first and a second arm 131, 132 which extend in the direction of travel, wherein an outer end of first arm 131 is positioned close to a first displacing means 21 on the first axle and wherein the other outer end of the first arm is positioned close to a first outer side 18 of support structure 15; and wherein an outer end of second arm 132 is positioned close to a second displacing means 23 on first axle 141 and wherein the other outer end of the second arm is positioned close to a second outer side 19 of support structure 15. The mobile apparatus comprises a second axle 142 which is connected to displacing means 22, 24, and provided between second axle 142 and support structure 15 are one or more arms 131, 132 which are pivotally connected at their outer ends. First axle 141 is further coupled pivotally by a V-shaped arm 150 to the support structure, wherein V-shaped arm 150 is configured to realize a lateral stabilization of the first axle relative to support structure 15. Second axle 142 of the main frame is also provided with a V-shaped arm 150 between second axle 142 and support structure 15. It is noted that the V-point of V-shaped arms 150, which is now connected to respectively first axle 141 and second axle 142, can also be connected to support structure 15, wherein the outer ends of the V are then connected to first axle 141 and second axle 142. This is illustrated in FIG. 10D. Instead of V-shaped arms, two separate arms can also be used which can together bring about the effect of the V-shaped arms.

FIGS. 10E and 10F illustrate a first and a second embodiment in which the mobile apparatus is provided with respectively tyres and caterpillars and in which a damping system is provided. The mobile apparatus comprises a first axle 141 and a second axle 142 which are connected to respective displacing means 21, 22. Between each axle 141, 142 and main frame 10 can be provided one or more arms 131, 132 which are pivotally connected at their outer ends. Each axle 141, 142 can further be coupled pivotally by a V-shaped arm 150 to main frame 10, wherein V-shaped arm 150 is configured to realize a lateral stabilization of each axle 141, 142 relative to main frame 10. A measuring instrument (not shown) is further provided for the purpose of measuring position data representative of the position of main frame 10 and/or sub-frame 30. The mobile apparatus comprises a control system (provided in sub-frame 30 or in main frame 10) which is configured to control damping system 110 in accordance with the measured position data. The control system can then be configured, on the basis of the measured position data, to change the position of sub-frame 30 using damping system 110. Sub-frame 30 can in this way be positioned for instance substantially level or substantially parallel to the horizontal so that it operates more safely and more efficiently as illustrated in FIGS. 10E and 10F. It is also possible to mount sub-frame 30 at a fixed angle, for instance while performing operations on an uneven terrain. According to yet another possibility, the angle is varied in accordance with the measured position data, for instance in order to obtain a stable road-holding when the mobile apparatus travels by road.

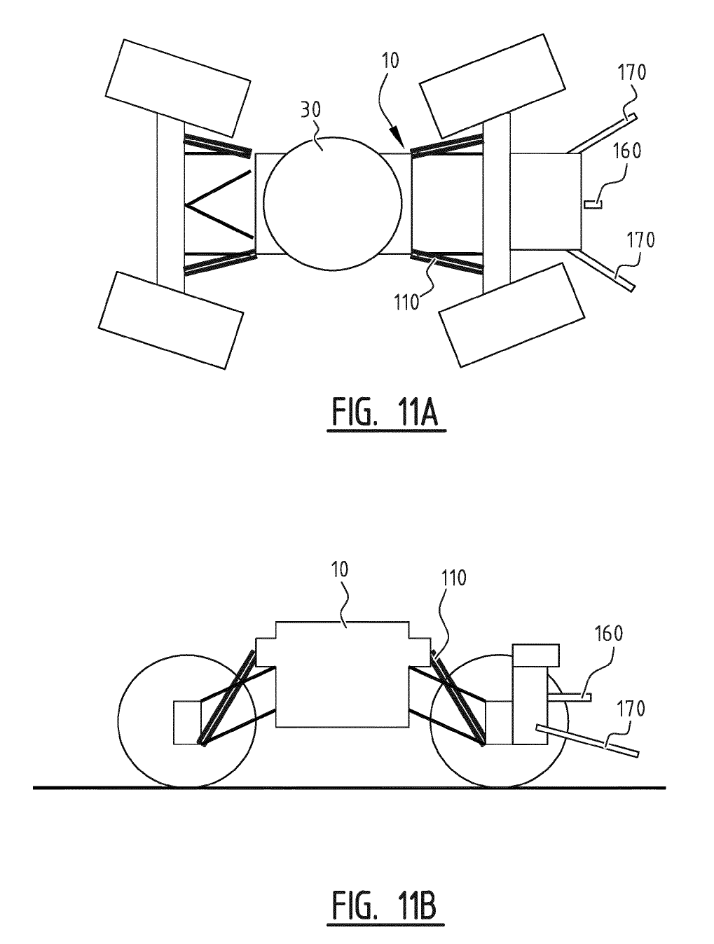

In the variant of FIGS. 11A and 11B a lifting device 170 and a power takeoff 160 are connected to at least one displacing means or to an axle coupled to a displacing means, and thereby not spring-mounted and/or damped relative to at least said displacing means.

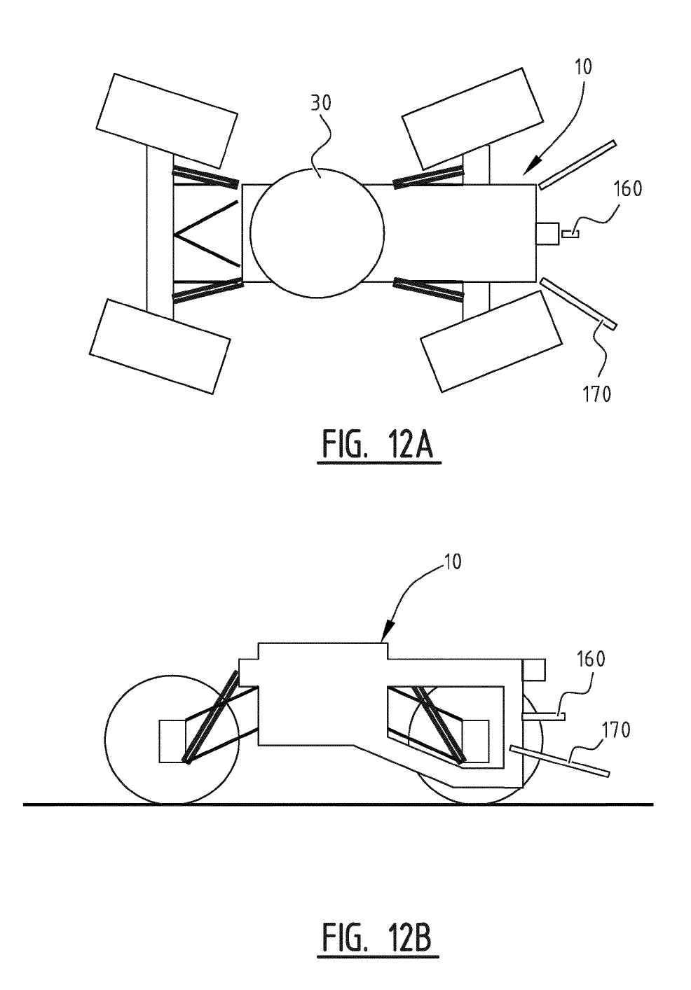

In the variant of FIGS. 12A and 12B a lifting device 170 and a power takeoff 160 arc connected to a spring-mounted part of the main frame, and thereby spring-mounted and/or damped relative to at least one displacing means or an axle with displacing means.

The skilled person will appreciate that the invention is not limited to the above described embodiments and that many modifications and variants are possible within the scope of the invention, which is defined solely by the following claims.

1. A mobile apparatus, comprising:
a main frame with displacing means;
a sub-frame connected rotatably to the main frame;
an operating arm connected to the sub-frame and comprising at least a first, a second and a third articulation which are connected pivotally to each other, which operating arm is configured to fold the at least three articulations adjacently or against each other in the transport position and to be transformed from an operating position to a transport position; wherein the third articulation is foldable against the second articulation, and these third and second articulations are together foldable along the first articulation, wherein at least one of the second and third articulations is locked relative to the first articulation or relative to the sub-frame;
drive members configured to move at least the first and second articulations of the operating arm;
operating instruments controllable by a driver and provided close to a driver position on the sub-frame;
measuring instruments configured to measure position data representative of at least: a position of the second articulation relative to the first articulation or relative to the sub-frame; and/or a position of the first articulation relative to the sub-frame; and/or a position of the third articulation relative to the first articulation and/or relative to the second articulation and/or relative to the sub-frame; and
a control system configured to receive operational data from the operating means and position data from the measuring instruments; and configured to control the drive members in accordance with the received position data and the operational data, wherein the control system is configured to allow a transformation to the transport position only when the angle between the first articulation and the sub-frame lies within a predetermined range.

2. The mobile apparatus as claimed in claim 1, wherein the control system is configured to control the drive members such that a drive member of the second articulation and/or a drive member of the third articulation continues to generate force after reaching an end point in order to hold the articulation in position during locking and/or unlocking of one of the articulations; and/or that a measuring instrument is provided in order to determine whether locking components of an articulation are in the correct position before locking/unlocking is performed.

3. The mobile apparatus as claimed in claim 1, wherein the control system is configured to control the drive members such that the speed at which the second articulation moves relative to the first articulation and/or the third articulation relative to the second articulation is modified in accordance with the position data.

4. The mobile apparatus as claimed in claim 1, wherein the control system is configured to perform the transformation to the transport position in a first and a second phase; wherein in the first phase the operating arm is brought into a starting position in which the first articulation makes an angle lying within a predetermined range with the sub-frame and the second articulation makes an angle lying in a predetermined range with the first articulation; and wherein in the second phase the operating arm is moved to the transport position.

5. The mobile apparatus as claimed in claim 1, wherein the operating instruments comprise a transport position command instrument which can be operated by a driver in order to move the operating arm to the transport position and which is configured to transmit a transport position command to the control system; and that the control system is configured for the purpose, after receiving a transport position command, of controlling the drive members on the basis of the position data during the movement to the transport position.

6. The mobile apparatus as claimed in claim 1, wherein the control system is configured to receive position data from the measuring instruments at successive points in time during movement from the operating position to the transport position and to control the drive members in accordance with these position data received at successive points in time.

7. The mobile apparatus as claimed in claim 1, wherein the measuring instruments are configured to measure position data representative of the distance between the main frame and the displacing means and/or of the rotation of the sub-frame relative to the main frame.

8. The mobile apparatus as claimed in claim 1, wherein the measuring instruments comprise one or more of the following: a linear measuring instrument, a position or contact measuring instrument, an angle measuring instrument, a rotation measuring instrument.

9. The mobile apparatus as claimed in claim 1, wherein the control system is configured to allow a transformation to the transport position only when the angle between the main frame and the sub-frame lies within a predetermined range.

10. The mobile apparatus as claimed in claim 1, wherein the control system is configured, during transformation of the operating arm to the transport position and vice versa, to control only the articulations of the operating arm, and optionally an articulation lock, and no other movements of the mobile apparatus can be controlled.

11. The mobile apparatus as claimed in claim 1, wherein, further comprising:
a damping system between the main frame and at least one displacing means for damping the movement of the main frame relative to the displacing means;
wherein the control system is configured to block the damping system in accordance with the received operational data; wherein the damping system is preferably active between the main frame and all displacing means.

12. The mobile apparatus as claimed in claim 11, wherein a measuring instrument is integrated into the damping system.

13. The mobile apparatus as claimed in claim 1, wherein the displacing means comprise at least a first and a second displacing means, and wherein the mobile apparatus further comprises a damping system with:
a first damping unit between the main frame and the first displacing means for damping the movement of the main frame relative to the first displacing means; and
a second damping unit between the main frame and the second displacing means for damping the movement of the main frame relative to the second displacing means independently of the first damping unit; and
wherein the control system is configured to control the first and second damping units in accordance with the received operational data; wherein a first measuring instrument for measuring a position of the main frame relative to the first displacing means is preferably integrated into the first damping unit (113); and a second measuring instrument for measuring a position of the main frame relative to the second displacing means is integrated into the second damping unit.

14. The mobile apparatus as claimed in claim 1, wherein the damping system comprises one or more of the following:
at least one damping unit comprising a cylinder or a bellows under pressure; and
at least one damping unit with associated damping characteristic, wherein the control system is configured to set the or each damping characteristic.

15. The mobile apparatus as claimed in claim 1, wherein the damping system comprises a plurality of damping units and that the control system is configured to block one or more of the damping units in a blocked position, which blocked position can for instance be a high blocked position, in which the main frame is located in a highest position relative to the displacing means, a low blocked position, in which the main frame is located in a lowest position relative to the displacing means, or a blocked intermediate position located between the highest and lowest position.

16. The mobile apparatus as claimed in claim 1, wherein the control system is configured to block the damping system in accordance with angle data representative of the rotation of the sub-frame relative to the main frame.

17-18. (canceled)

19. The mobile apparatus as claimed in claim 1, further comprising a bumper system coupled to the operating arm in the transport position; which bumper system is configured and shaped to limit the impact of the operating arm on other road users in the case of collision.

20. The mobile apparatus as claimed in claim 1, further comprising: a lifting device mounted on the main frame; and a bumper system coupled to the lifting device in the transport position; which bumper system is configured and shaped to limit the impact of the lifting device on other road users in the case of collision.

21. A mobile apparatus comprising:
a main frame with displacing means;
a sub-frame connected rotatably to the main frame;
an operating arm connected to the sub-frame and comprising at least a first and a second articulation which are connected pivotally to each other, which operating arm can be transformed from an operating position to a transport position;
drive members configured to move at least the first and second articulations of the operating arm;
operating instruments controllable by a driver and provided close to a driver position on the sub-frame;
measuring instruments configured to measure position data relating to a position of the first articulation and a position of the second articulation; and
a control system configured to receive operational data from the operating means and position data from the measuring instruments; and configured to control the drive members in accordance with the received position data and the operational data.

22. A mobile apparatus comprising:
a main frame;
displacing means;
a sub-frame connected rotatably to the main frame;
an operating arm connected to the sub-frame;
drive members configured to move the operating arm;
a damping system between the main frame and at least one displacing means for damping the movement of the main frame relative to the displacing means;
operating instruments controllable by a driver and provided close to a driver position on the sub-frame; and
a control system configured to receive operational data from the operating means; and
configured to block the damping system in accordance with the received operational data.
